(19) United States
(12) Patent Application Publication
(10) Pub. No.: US 2003/0072566 A1
(43) Pub. Date: Apr. 17, 2003

(54) Device and method for the analysis of one or more signals with wide dynamic range

(75) Inventor: Jean-Luc Pastre, Paris (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THOMSON-CSF, PARIS (FR)

(21) Appl. No.: 09/864,297

(22) Filed: May 25, 2001

(30) Foreign Application Priority Data
May 26, 2000 (FR) 00 06764

(51) Int. Cl. G03B 37/02

(52) U.S. Cl. 396/20

(57) ABSTRACT

A device to analyze or reconstruct one or more signals Ij coming from one or more light sources, comprises: means to separate the signals Iⱼ into at least two signals Iⱼ₁ and Iⱼ₂, at least two channels V₁, V₂ respectively possessing a gain G₁, G₂ and a dynamic range D₁, D₂, said channels having at least one sensor and being adapted to obtain, at output, a signal I′ⱼ₁, I′ⱼ₂ with amplitudes Aⱼ₁(t), Aⱼ₂(t), a device for the processing of the signals I′ⱼ₁, I′ⱼ₂ adapted to memorizing the amplitude Aⱼ₁(t), Aⱼ₂(t) of at least one of the two signals I′ⱼ₁, I′ⱼ₂ when I′ⱼ₁ and/or I′ⱼ₂ is below a threshold value Sₘₐₓ and to determining the amplitude Aⱼ(t) of the corresponding signal I′ⱼ. Streak camera with wide range of amplitude.

### BACKGROUND OF THE INVENTION

1. Field of the Invention

The present invention relates to a device for the analysis or reconstruction of one or more signals with wide dynamic range and to a method for the implementation of this device.

It is used especially for the analysis of brief light pulses with time resolution values of less than one picosecond.

It can be used for example to analyze many simultaneous signals with wide dynamic range, conveyed by optic fibers.

It can also be used in all fields implementing signals with wide dynamic range.

2. Description of the Prior Art

Various devices are described in the prior art to analyze fast light signals.

For example, streak cameras are widely used. The image converter tube is the central element of this device. It is a vacuum tube consisting of a photocathode, acceleration and focusing electrodes, deflection plates and a phosphorus screen. The light signal to be analyzed is projected on the photocathode through a thin slot. The electrons produced by the photocathode in the tube are accelerated and focused. The electron beam thus obtained is deflected at high speed by the deflection plates and scans the phosphorus screen. The image obtained on the screen therefore represents all the variations of the input signal in the course of time. This fleeting image is recorded either by photography or by a monoshot video camera associated with an image memory.

For low or medium scanning speeds, the time resolution is equal to the product of the spatial resolution multiplied by the scanning speed. For example, for a spatial resolution of 0.1 millimeters and a scanning speed of 10 millimeters per nanosecond, the time resolution is 10 ps.

When the amplitude of the input signal of a converter tube increases, a phenomenon of saturation appears, causing deterioration in the space and time resolution. This phenomenon is due chiefly to the space charge in the tube because the excessively high density of electrons defocuses the beam owing to the forces of repulsion between the electrons.

It has been shown that the current density admissible in the tube depends on the distance between the photocathode and the acceleration gate and on the acceleration voltage applied between these two electrodes. There is therefore a physical limit to this current density due to the phenomena of electrical disruption. The maximum current density cannot exceed a few tens of amperes per square centimeter, and the saturation current density corresponds to a maximum number of electrons per time unit.

Thus, in the above example, for a beam with a diameter of 0.1 millimeters and for a time resolution of 10 picoseconds, a maximum number of about 500,000 electrons per time unit is computed when the current density reaches 100 amperes per square centimeter.

The smallest measurable level is limited by the measurement noise. In a streak tube, the noise results from the corpuscular nature of the photocurrent in the tube. For a given number N of photoelectrons per time unit, Poisson's law states that the signal-to-noise ratio is equal to the square root of this number N. Thus, to obtain a signal-to-noise ratio of 100, the electron beam must have 10,000 electrons per time unit.

The applications of streak cameras may thus be limited by their dynamic range of amplitude, namely the value of the ratio between the saturation signal and the smallest measurable signal. Thus, in the example given here above, this dynamic range is 50. This is relatively limited for certain applications. The dynamic range may vary from some tens to some hundreds, depending on the physical characteristics of the tube and the speed of analysis.

The French patent FR 2 660 822 discloses a camera with two CCD sensors whose output signals are combined to obtain a wider dynamic range of amplitude in order to reconstitute an image at a given point in time.

Hereinafter in the description, the word “sensor” designates a streak camera or again a CCD camera or again any device with an identical or substantially identical function.

### SUMMARY OF THE INVENTION

An object of the present invention is a device for the analysis of light signals with a wide dynamic range of amplitude. It also relates to a streak camera with wide dynamic range.

To this end, an object of the invention is a device used to analyze or reconstruct one or more signals Ij coming from one or more light sources. It comprises at least:

means to separate the signals Iⱼ into at least two signals Iⱼ₁ and Iⱼ₂,

at least two channels respectively possessing a gain and a dynamic range, said channels having at least one sensor and being adapted to obtain, at output, a signal I′ⱼ₁, I′ⱼ₂ with amplitudes respectively equal to Aⱼ₁(t), Aⱼ₂(t),

a device for the processing of the signals I′ⱼ₁, I′ⱼ₂ adapted to memorizing the amplitude Aⱼ₁(t), Aⱼ₂(t) of at least one of the two signals I′ⱼ₁, I′ⱼ₂ when I′ⱼ₁ and/or I′ⱼ₂ is below a threshold value Sₘₐₓ and to determining the amplitude Aⱼ(t) of the corresponding signal I′ⱼ.

The invention also relates to a method used to analyze a signal with a wide dynamic range. The method comprises at least the following steps:

(a) separating the signal to be analyzed into at least two signals Iⱼ₁, Iⱼ₂,

(b) making each signal Iⱼ₁, Iⱼ₂ go through at least one channel comprising at least one sensor, each of the channels having a dynamic range D₁, D₂,

(c) memorizing each signal I′ⱼ₁ and I′ⱼ₂ coming from two channels V₁ and V₂ in digital form so as to obtain, for an index j, the values of the corresponding amplitudes Aⱼ₁(t) and Aⱼ₂(t),

(d) reading the values Aⱼ₁(t) and comparing each of the values with a threshold value Sₘₐₓ,

(e) if Aⱼ₁(t) is smaller than the threshold value Sₘₐₓ, memorizing the value of the amplitude Aⱼ₁(t) and the corresponding instant t,

(f) if Aj_{I1}(t) is greater than the threshold value Sₘₐₓ, then memorizing the value Aⱼ₂(t) and the corresponding instant t,

(g) determining the resultant amplitude signal Aⱼ(t) from the pairs of values having an amplitude [(Aⱼ₁(t), t); (Aⱼ₂(t), t)].

The device and method according to the invention can be applied to a streak camera with wide dynamic range.

The invention especially has the following advantages:

it can be used to analyze one or more signals with wide dynamic range,

it gives a wide dynamic range on a large number of simultaneous signals,

for the user, it is like a standard camera without any particular difficulties of use,

it can be used to analyze numerous signals conveyed by optic fibers.

### BRIEF DESCRIPTION OF THE DRAWINGS

Other features and advantages of the invention shall appear from the following description made by way of an illustration that in no way restricts the scope of the invention. This description is made with reference to the appended drawings, of which:

FIG. 1 is a block diagram of an analysis device according to the invention,

FIG. 2A is a sectional view of an exemplary structure of a converter tube and FIG. 2B shows the distribution of the points corresponding to the signal analyzed on the phosphorus screen of a converter tube,

FIG. 3 shows a gain curve of the converter tubes,

FIG. 4 is a schematic view of a signal-processing algorithm,

FIG. 5 shows an alternative embodiment of the device described in FIG. 1.

### MORE DETAILED DESCRIPTION

The following description, given by way of an illustration that in no way restricts the scope of the invention, pertains to the analysis of a signal. This signal takes, for example, the form of a light beam designated by Iⱼ.

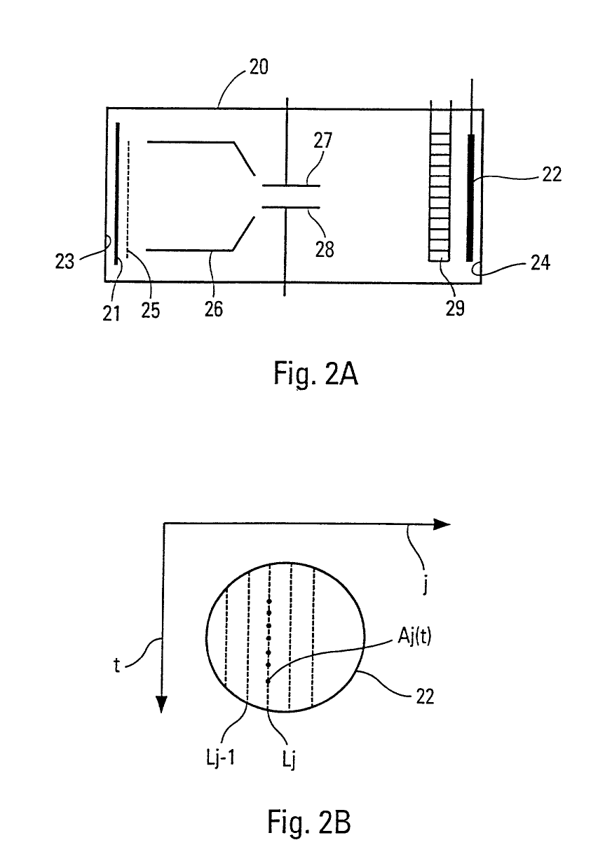

In certain cases of application, the signal could have a certain spatial width and be subdivided into several sub-signals Iⱼ₋₁, Iⱼ, Iⱼ₊₁ as described in FIG. 2B, j being an index linked to the position of the sub-signal in space.

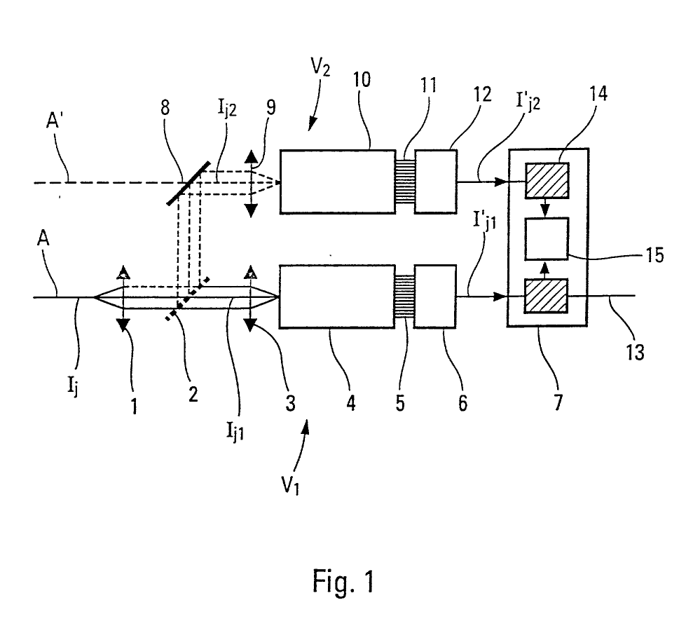

FIG. 1 shows the following on a first optical axis A: a first lens 1 used to collimate the signal Iⱼ to be analyzed coming from a light source, a first channel V₁ comprising a semi-reflecting plate 2 inclined with respect to the optical axis A, having especially the function of fractionating or separating the signal Iⱼ, for example into two signals Iⱼ₁ and Iⱼ₂, a second lens 3 positioned upline from a converter tube 4 that is itself coupled, for example by a set of optic fibers 5, to a video camera 6. The output of the video camera is linked to a signal-processing device 7. The first channel has a gain G₁ and a dynamic range D₁.

A second optical axis A′ has the following in succession: a mirror 8, a lens 9 substantially identical to the lens 3 positioned upline from a converter tube 10 coupled to a camera 12, for example by means of optic fibers 11. These different elements, along with the semi-reflecting plate 2, form a second channel V₂ having a gain G₂ and a dynamic range D₂. The output of the camera 12 is linked with the signal-processing device 7. Similarly, the second channel V₂ has a gain G₂ substantially identical to the gain G₁ and a dynamic range D₂ substantially equal to the dynamic range D₁.

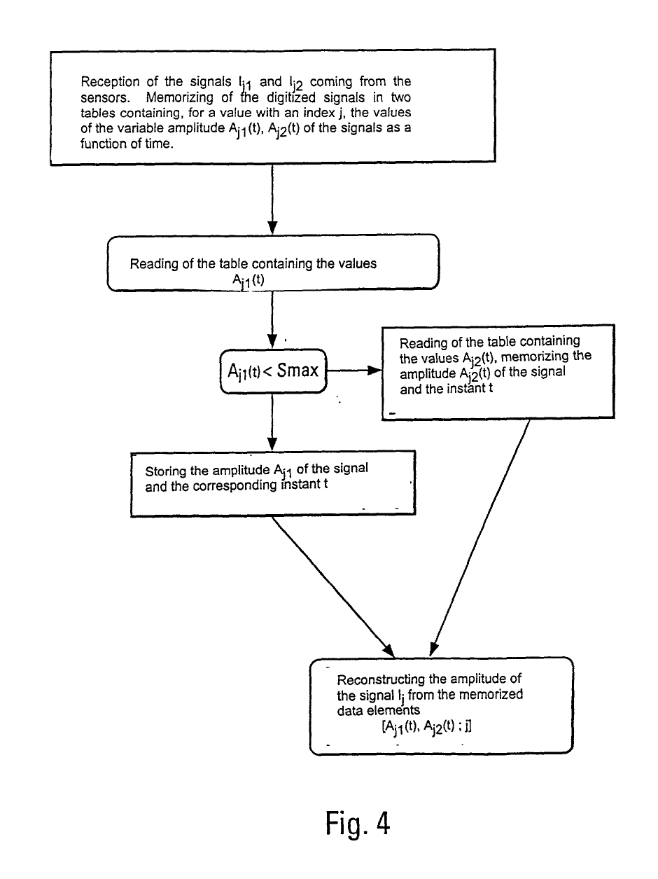

The signal-processing device 7 has, for example, two image memories 13, 14 known to those skilled in the art, linked with a computer 15 such as a PC receiving the two signals I′ⱼ₁ and I′ⱼ₂. Each of the image memories 13, 14 receives and digitizes the analog signals I′ⱼ₁ and I′ⱼ₂, coming from the video cameras 4, 6. The digitized video signals I′ⱼ₁, I′ⱼ₂ are then memorized, for example in one of the memories of the computer 15, before they are processed by an appropriate algorithm that is described with reference to FIG. 4. The computer 15 has the means needed to implement the algorithm, especially memories, a central processing unit, etc., known to those skilled in the art.

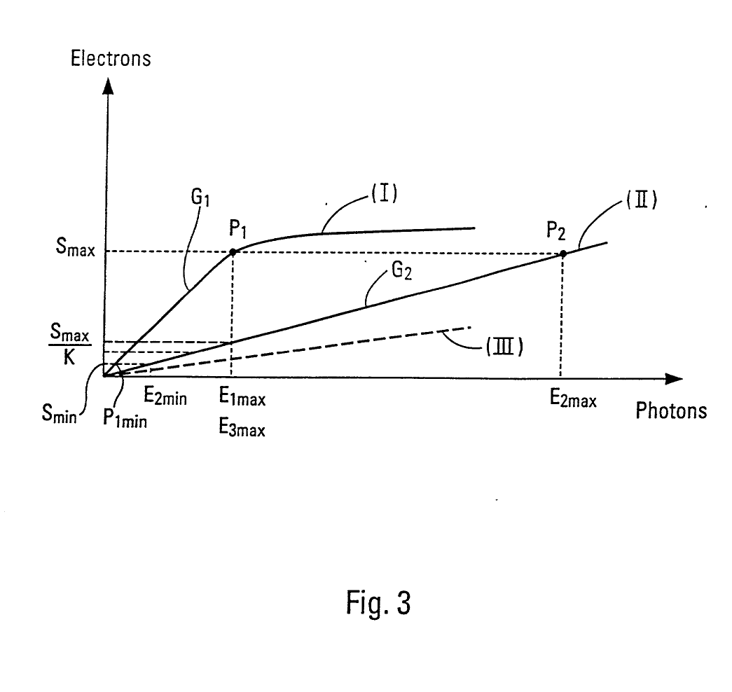

The characteristics of the semi-reflective plate 2, for example, its attenuation ratio K, are determined as a function of the dynamic range of the converter tubes which are substantially identical to those of the two channels V₁ and V₂ according to the method as described with reference to FIG. 3.

The semi-reflective plate may be replaced by a lossy mirror whose attenuation coefficient is determined according to an identical principle.

The lenses may be replaced by concave mirrors.

The coupling between a converter tube and a video camera may be obtained:

directly, the video camera being then equipped with a optic-fiber window,

by means of optical lenses or again photographic objectives.

Couplings of this kind are known to those skilled in the art and shall therefore not be described in detail.

The video camera is for example a semiconductor tube or sensor.

When the signal coming from the video camera is a digital signal, the digitizing operation performed by the processing device is no longer necessary. This processing device comprises for example a memory and an interface adapted to the digital signal received.

### Working of the Device

The light signal to be analyzed Iⱼ is collimated by the lens 1. The beam thus obtained partly crosses the reflected plate 2, the fraction Iⱼ₁ of the light that has crossed is focused by the lens 3 on the photocathode (21 FIG. 2A) of the converter tube 4. The image of the phosphorus screen (22 FIG. 2A) is then picked up by the video camera 6 through the optic fiber coupling 5 in order to produce the analog video signal I′ⱼ₁.

The fraction of the light Iⱼ₂ reflected by the semi-reflective plate 2 corresponds to a small fraction of the incident light Iⱼ. It is sent back to the mirror 7 and then focused by the lens 3 on the photocathode of the converter tube 10. The image of the screen is then picked up through the optic fiber coupling 11 by the camera 12. The analog video signal I′ⱼ₂ is digitized in the image memory 14.

The two memorized signals are then analyzed according to the algorithm described in detail in FIG. 4.

FIG. 2A shows a sectional view of an exemplary structure of a converter tube used in the device according to the invention along with its operation.

The converter tube is for example an electron tube comprising a vacuum chamber 20, a photocathode 21 and a phosphorus screen 22 deposited for example on the inner ends 23, 24 of the chamber which is cylindrical for example, two electrodes 25, 26 as well as a pair of deflector plates 27, 28.

A wafer 29 comprising microchannels may be positioned, if necessary, before the phosphorus screen 22.

The electrons emitted by the photocathode 21 are deflected by the electrical field formed between the two deflector plates 27, 28 and are multiplied by the wafer 29 before being applied to the phosphorus screen 22 in their order of emission.

According to another embodiment, the photocathode of the tube is made for example on a fiber optic plate. In this case, the set of elements forming the input optical system (lenses, separating plate, etc.) consists for example of optic fibers and fiber couplers.

FIG. 2B shows the signal or signals I′ⱼ received on the phosphorus screen 22. A signal I′ⱼ corresponds to a signal Iⱼ after the crossing of the optical input and the sensors, herein consisting of the above-mentioned converter tube. A signal I′ⱼ has a position Lⱼ, referenced for example with respect to an edge of the phosphorus screen. The amplitude in luminosity Aⱼ(t) is variable in time.

The abscissa axis referenced j corresponds to the spatial distribution of the discrete signals separated from one another and the ordinate axis t represents the evolution in time of the signal corresponding to the variations in amplitude of intensity.

Along the ordinate axis, the correspondence between distance and time is given by the scanning speed.

In certain cases, there is continuity and the points corresponding to the different signals may cover practically the entire surface of the phosphorus screen.

When the signal to be analyzed consists of several light signals, for example when the light source is formed by several optic fibers positioned side by side, each producing a light signal Iⱼ, the points corresponding to the different light signals are distributed on the phosphorus screen along several lines Lⱼ.

### Choice of the Value of the Attenuation Coefficient of the Separating Plate

FIG. 3 provides a clear explanation of the way of determining the value of the attenuation coefficient K of the semi-reflective plate separating the signal into several signals.

In this figure, the curve (I) shows the curve of the gain G₁ of the first channel V₁, the curve (II) shows the curve of the gain G₂ of the second channel V₂ and the curve (III) shows the curve of the gain G for the borderline value of the coefficient K.

These curves are plotted in a graph whose abscissa axis represents the number of photons contained in the signal to be analyzed Iⱼ and whose ordinate axis shows the amplitude of the signals collected on the screen of the tubes, for example the signals I′ⱼ₁ and I′ⱼ₂.

The dynamic range Dᵢ of a channel Vᵢ is defined on the basis of the minimum threshold with coordinates (Eₘᵢₙ, Sₘᵢₙ), below which the signal-to-noise ratio is smaller than a minimum tolerable value and a maximum threshold with coordinates (Eₘₐₓ, Sₘₐₓ) corresponding to the saturation of the converter tube, namely the limit of reception of the signal without deformation.

Thus, the dynamic range D₁ of the first channel V₁ is equal to:

$${D}_{1} = \frac{{E}_{1 max}}{{E}_{1 min}} = \frac{{S}_{max}}{{S}_{min}} \qquad ( 1 )$$

and the dynamic range D₂ of the second channel V₂ is equal to:

$${D}_{2} = \frac{{E}_{2 max}}{{E}_{2 min}} = \frac{{S}_{max}}{{S}_{min}} \qquad ( 2 )$$

### The Dynamic Range of the System Comprising Two Tubes

The dynamic range of the system is equal to the ratio between the biggest measurable input signal, namely E₂ₘₐₓ and the smallest measurable signal namely E₁ₘᵢₙ.

$$D = \frac{{E}_{2 max}}{{E}_{1 min}} \qquad ( 3 )$$

Should the two tubes of the system have substantially identical gains, the ratio between the slopes of the curves (I) and (II) is equal to the coefficient of attenuation between the two channels. Consequently,

E₂max=K×E₁max

[symbol] the value of K is chosen to meet this relationship.

And therefore the dynamic range D of the system with two tubes is obtained by the relationship:

$$D = K \times \frac{{E}_{1 max}}{{E}_{1 min}} = K \times {D}_{1}$$

The dynamic range of the system with two tubes is equal to or substantially equal to the dynamic range of a single tube multiplied by the attenuation ratio K.

The greatest possible dynamic range for the system is obtained from the greatest value of the coefficient K. This greatest value of K is determined for example by the curve (II) of FIG. 3 for which the smallest measurable value on the second channel V₂ is equal to the greatest measurable value for the first channel V₁. Indeed, beyond this limit, there would be input values for which the first tube would be saturated while the second tube would have an excessively low signal-to-noise ratio.

Thus, the limit value for the coefficient K is attained when:

E₃ₘᵢₙ=E₁ₘₐₓ

This means that:

$$K = \frac{{E}_{3 min}}{{E}_{1 min}} = \frac{{E}_{1 max}}{{E}_{1 min}} = {D}_{1}$$

The greatest dynamic range for the two-tube system will be obtained for K=D₁ (5)

and the value of K will be chosen so that it is as close as possible to the value of the dynamic range D₁ of the first channel V₁.

An exemplary implementation of the method according to the invention for the device described in FIG. 1 is given here below.

### Steps of the Method

For the signal Iⱼ with a given index j, the method comprises for example the following steps:

a) separating the signal Iⱼ into at least two signals Iⱼ₁ and Iⱼ₂ with Iⱼ₁=K*Iⱼ₂ where K is the attenuation coefficient of the separating plate, K being fixed as a function of the dynamic range D₁ of the converter tube in order to meet the relationship E₂ max=K×E₁ max,

b) making the signals Iⱼ₁ and Iⱼ₂ go through respectively the conversion tubes 4, 10 and the video cameras 6, 12, two signals I′ⱼ₁ and I′ⱼ₂ being thus obtained at output of the two channels V₁, V₂,

c) when the signals I′ⱼ₁ and I′ⱼ₂ are analog signals, digitizing them by means of the image memory 13, 14 and storing them; the stored signals constitute for example two data banks taking the form of tables which, for a given index j, comprise the value of the amplitudes Aⱼ₁ of the signals after separation, as a function of the time t, these amplitude values herein being Aⱼ₁(t) and Aⱼ₂(t),

d) these two tables are read one after the other by the computer. For example, in an initial step, the computer compares the value of each amplitude Aⱼ₁(t) with a threshold value Sₘₐₓ determined from the characteristics of the converter tube 4 with a gain G₁,

e) if Aⱼ₁(t)≦Sₘₐₓ then the computer stores the pair [Aⱼ₁(t), t] in one of its memories,

f) if Aⱼ₁(t)>Sₘₐₓ then the computer reads the second table and stores the value Aⱼ₂(t) corresponding to the same instant t,

g) from the values Aⱼ₁(t), Aⱼ₂(t) stored and the corresponding values of t, the computer determines the amplitude Aⱼ(t) of the signal I′ⱼ, (the signal I′ⱼ being an image of the initial signal I to the nearest value of gain of the converters).

The selection and the memorizing of the amplitudes of the signals enable the formation of a digital signal that corresponds to the initial signal to the nearest value of gain of the system.

For a signal to be analyzed that is spatially distributed and identified in several positions j, the computer repeats the steps a) to g) for each index j.

According to another embodiment, the signal analysis system may comprise n tubes (n channels) each having a dynamic range Gₙ and (n−1) separating plates each having an attenuation coefficient Kₙ given for example by applying the relationships (4) and (5) explained here above with:

Kₙ≦Dₙ.

In this case, the signal Iⱼ to be analyzed is separated into several signals Iⱼₙ by means of several separating plates having an attenuation coefficient Kₙ whose values are chosen according to the mode described here above, and the signal is reconstructed or analyzed in the computer from the amplitudes of the signals Aₙ(t) memorized for a given position j or for all the positions j when the signal is also distributed spatially.

For example, for a system comprising three tubes each having a dynamic range D₁, D₂ and D₃, the step f) is replaced by a step f′) in which when Aⱼ₁(t)>Sₘₐₓ, the value Aⱼ₂(t) is compared with the maximum threshold value Sₘₐₓ and if Aⱼ₂(t)>Sₘₐₓ then the value Aⱼ₃(t) corresponding to the signal obtained by the third converter tube is memorized.

The amplitude of the signal is then obtained from all the amplitude values Aⱼ₁(t), Aⱼ₂(t) and Aⱼ₃(t) and from the corresponding temporal values t memorized for a given position j.

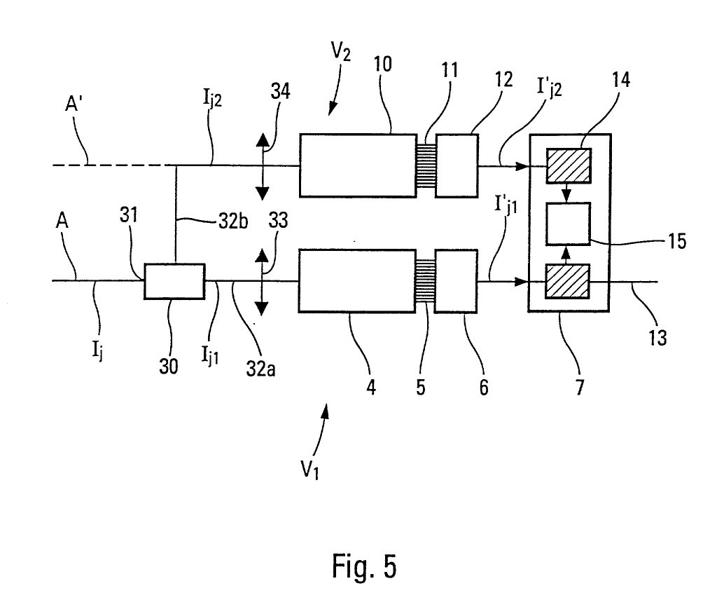

FIG. 5 gives a schematic view of an alternative embodiment for the device where the means used to separate the beam into the signal Iⱼ to be analyzed are constituted by an optic fiber coupler. The references identical to those used in FIG. 1 represent identical elements which shall therefore not be described again.

The optic fiber coupler 30 comprises for example an input 31 receiving the signal to be analyzed and one or more outputs 32i. In this exemplary embodiment, two outputs 32a and 32b have been shown.

Depending on the coupler used, the outputs 32i can be identical, namely the beam to be analyzed is separated into several beams Iⱼₙ that are identical or substantially identical, namely corresponding to one and the same fraction of the incident light. Or again, it is separated into n different beams Iⱼₙ, each beam corresponding to a fraction of the incident light Iⱼ, n being the number of possible outputs of the coupler.

As shown in FIG. 1, the fraction of the light Iⱼ₂ obtained by the second output 32b of the coupler corresponds to a small fraction of the incident light Iⱼ.

The two light beams Iⱼ₁ and Iⱼ₂ take the form of divergent beams that are converted into convergent beams by means of two lenses 33 and 34 positioned on the optical axes A and A′.

The beams are focused by these two lenses respectively on the photocathodes of the converter tubes 4 and 10 and analyzed according to the algorithm explained here above to explain the working of the device of FIG. 1.

Without departing from the framework of the invention, the device and the method described here above with respect to FIGS. 1 to 4 can be applied to:

analyzing a signal corresponding to the projection of a single light beam through a slot. In this case, the lens to collimate the beam is not necessary,

analyzing a linear image such as a spectrogram coming from a spectrometer or the section of a light physical phenomenon,

analyzing a signal formed by a row of optic fibers, each one conveying a distinct piece of information.

What is claimed is:

1. A device to analyze or reconstruct one or more signals Ij coming from one or more light sources, comprising at least:
means to separate the signals Iⱼ into at least two signals Iⱼ₁ and Iⱼ₂,
at least two channels V₁, V₂ respectively possessing a gain G₁, G₂ and a dynamic range D₁, D₂, said channels having at least one sensor and being adapted to obtain, at output, a signal I′ⱼ₁, I′ⱼ₂ with amplitudes Aⱼ₁(t), Aⱼ₂(t),
a device for the processing of the signals I′ⱼ₁, I′ⱼ₂ adapted to memorizing the amplitude Aⱼ₁(t), Aⱼ₂(t) of at least one of the two signals I′ⱼ₁, I′ⱼ₂ when I′ⱼ₁ and/or I′ⱼ₂ is below a threshold value Sₘₐₓ and to determining the amplitude Aⱼ(t) of the corresponding signal I′ⱼ.

2. A device according to claim 1, wherein the signal-processing device works as follows:
for a signal I′ⱼ corresponding to a given spatial position j
if the amplitude Aⱼ₁(t) is smaller than or equal to a threshold value Sₘₐₓ then the processing device stores the pair of values (Aⱼ₁(t), t),
if the amplitude Aⱼ₁(t) is greater than the threshold value Sₘₐₓ, then the processing device stores the pair of values (Aⱼ₂(t), t) and
from the stored values (Aⱼ₁(t), t), (Aⱼ₂(t), t) the device determines the corresponding values of amplitude Aⱼ(t) in order to obtain the signal I′ⱼ.

3. A device according to one of the claims 1 or 2, wherein said means of separating the signal Iⱼ have an attenuation coefficient K determined so that K is smaller than or equal to the dynamic range of at least one of said channels V₁, V₂.

4. A device according to claim 3, wherein the means of separation have a value of attenuation coefficient K substantially equal to the dynamic range of at least one of said channels V₁, V₂.

5. A device according to one of the claims 1 to 4, wherein the sensors are streak cameras.

6. A device according to one of the claims 1 to 5, comprising n channels having a dynamic range Dₙ, (n−1) means of separating the signal or signals Iⱼ.

7. A streak camera with wide dynamic range according to one of the claims 1 to 6.

8. A method to analyze a signal Iⱼ with a wide dynamic range, wherein it comprises at least the following steps:
(a) separating the signal to be analyzed into at least two signals Iⱼ₁, Iⱼ₂,
(b) making each signal Iⱼ₁, Iⱼ₂ go through at least one channel V₁, V₂ comprising at least one sensor, each of the channels having a dynamic range D₁, D₂,
(c) memorizing each signal I′ⱼ₁ and I′ⱼ₂ coming from the two channels V₁ and V₂ in digital form so as to obtain, for an index j, the values of the corresponding amplitudes Aⱼ₁(t) and Aⱼ₂(t),
(d) reading the values Aⱼ₁(t) and comparing each of the values with a threshold value Sₘₐₓ,
(e) if Aj1(t) is smaller than the threshold value Sₘₐₓ, memorizing the value of the amplitude Aⱼ₁(t) and the corresponding instant t,
(f) if Aj_{I1}(t) is greater than the threshold value Sₘₐₓ, then memorizing the value Aⱼ₂(t) and the corresponding instant t,
(g) determining the resultant amplitude signal Aⱼ(t) from the pairs of values having an amplitude [(Aⱼ₁(t), t); (Aⱼ₂(t), t)].

9. A method according to claim 8 wherein the signal is split up into several signals Iⱼ with j varying spatially, and wherein the steps (a) to (g) are reiterated for each of the values of j.

10. A method according to one of the claims 8 and 9 wherein the threshold value Sₘₐₓ corresponds to the value of saturation of the sensor with the smallest dynamic range.

11. A method according to one of the claims 8 to 10, wherein a sensor comprises a streak camera.

12. A method according to one of the claims 8 to 10, wherein the signal to be analyzed Iⱼ corresponds to the projection of a single laser beam through a slot.

13. A method according to one of the claims 8 to 10, wherein the analyzed signal Iⱼ is a linear image coming from a spectrometer or the section of a physical phenomenon.

14. A method according to one of the claims 8 to 10, wherein the signal to be analyzed Iⱼ is a signal formed by a row of optic fibers, each of the fibers producing a signal having an index j.
